(19) United States
(12) Patent Application Publication
(10) Pub. No.: US 2012/0299765 A1
(43) Pub. Date: Nov. 29, 2012

(54) COMPACT SMART ANTENNA FOR MOBILE WIRELESS COMMUNICATIONS

(75) Inventors: Yikun Huang, Bozeman, MT (US); Andy Olson, Bozeman, MT (US); Will G. Tidd, Bozeman, MT (US); Aaron S. Traxinger, Bozeman, MT (US); Richard Wolff, Bozeman, MT (US)

(73) Assignees: ADVANCED ACOUSTIC CONCEPTS, Hauppauge, NY (US); MONTANA STATE UNIVERSITY, Bozeman, MT (US)

(21) Appl. No.: 13/468,666

(22) Filed: May 10, 2012

Related U.S. Application Data
(63) Continuation of application No. PCT/US10/56207, filed on Nov. 10, 2010.
(60) Provisional application No. 61/259,909, filed on Nov. 10, 2009.

(51) Int. Cl. G01S 13/06; H01Q 3/12

(52) U.S. Cl. 342/81; 342/374

(57) ABSTRACT

A compact, high gain 8-element circular smart antenna is able to scan a beam azimuthally through 360°. The 8-element array is placed on a ground skirt and connected to an 8-channel beamforning board via a transfer plate. Each channel has two T/R switches, one band pass filer, one power amplifier, two low noise amplifiers, one phase shifter, and one attenuator. The 8-channel-signal is combined through power splitters/combiners and then sent to a connected radio. An FPGA chip controls the digital phase shifters, attenuators and switches for signal searching, beamforming and tracking. The smart antenna can be operated as a compact switched beam system or with an additional processor as an adaptive array system. The smart antenna is capable of tracking mobile targets, directionally communicating with desired users, suppressing interference and jamming, and enabling long range communications with high throughput and reliable connection because of its high antenna gain.

### RELATED APPLICATION

This application is a continuation of International Application No. PCT/U.S. 2010/056207, filed Nov. 10, 2010, entitled “Compact Smart Antenna for Mobile Wireless Communications,” which claims priority to U.S. Patent Provisional Application No. 61/259,909, filed Nov. 10, 2009, entitled “Compact Smart Antenna for Mobile Wireless Communications”; each of which is incorporated herein by reference in their entireties.

### GOVERNMENT RIGHTS STATEMENT

This invention was made with government support under grant number N66001-08-D-0116 awarded by the Navy and grant number 0519403 awarded by the National Science Foundation. The government has certain rights in the invention.

### BACKGROUND

This invention relates to smart antennas, such as for example, high gain smart antennas suitable for a mobile or fixed relay node for wireless communications over long distances.

Smart antennas were initially developed during WWII for military use but have seen only limited commercial use due to high costs and large electronic processing delays. Smart antennas have become more cost-effective with advancements in digital signal processing (DSP) technology that has become cheaper and more effective. Known smart antennas include an array of antenna elements, radio transceivers for each element, a signal processor, and controllable phase shifters and attenuators to change the amplitude and phase of the signals for each of the antenna elements. The outputs of each of the antenna elements are periodically measured, and an algorithm in the signal processor uses this data to form the desired antenna pattern by controlling the phase shifters and attenuators.

Two types of known smart antennas exist: switched beam and adaptive array. For a switched-beam system, a set of specific beam patterns is formed with the main lobe towards the mobile node. The antenna system monitors the signal strength and switches among the lobes periodically to update beam selection. This antenna design improves performance by increasing signal strength and suppressing interferences that are not in the same direction as the signal. If interference is within the same lobe as the signal, however, the interference will not be suppressed. In contrast, an adaptive-array system uses sophisticated signal processing algorithms to distinguish continuously among the desired signal and interferences, and can form an unlimited number of beam patterns to improve signal strength and suppress interferences.

Both approaches have their advantages and disadvantages. The adaptive array offers higher gain than the switched beam array and greater interference rejection. Adaptive arrays may include longer computational time to converge to optimal patterns, and thus may not be suitable for real time, high-data-rate communications having a large number of highly mobile nodes and interferences. In a system having considerable interference, tracking the exact location of the nodes can increase system performance, and therefore the adaptive array may be a better choice. In a system having low interference, however, a switched-beam array may be adequate because it is less costly and it can produce a signal gain comparable to an adaptive array.

The techniques mentioned above were mainly developed for a uniform linear array (ULA). Although some algorithms have been expanded for uniform circular arrays (UCA), the spatial geographic advantage of a UCA has not been taken into account. The UCA offers many advantages over ULAs in the sense that UCAs are capable of providing 360° azimuthal coverage and information about sources' elevation angles. In addition, a UCA is able to electronically rotate the beam in the plane of the array without significantly changing the beam pattern.

Thus, a need exists for improved uniform circular array antenna systems. A need also exists for a broadband antenna system such that a radio is able to select desired communication channels for high quality of service (QoS) in harsh, unpredictable communication environment.

### SUMMARY OF THE INVENTION

In one embodiment, a compact, high gain 8-element circular smart antenna is able to scan a beam azimuthally through 360°. The 8-element array is placed on a ground skirt and connected to an 8-channel beamforning board via a transfer plate. Each channel has two T/R switches, one band pass filer, one power amplifier, two low noise amplifiers, one phase shifter, and one attenuator. The 8-channel-signal is combined through power splitters/combiners and then sent to a connected radio. An FPGA chip controls the digital phase shifters, attenuators and switches for signal searching, beamforming and tracking The smart antenna can be operated as a compact switched beam system or with an additional processor as an adaptive array system. The smart antenna is capable of tracking mobile targets, directionally communicating with desired users, suppressing interference and jamming, and enabling long range communications with high throughput and reliable connection because of its high antenna gain.

### BRIEF DESCRIPTION OF THE DRAWINGS

FIG. 1 is a schematic illustration of a smart antenna according to an embodiment.

FIG. 2 is a schematic illustration of a uniform circular array with a ground skirt according to an embodiment.

FIG. 3 is a top view of a transfer plate according to an embodiment.

FIG. 4 is an internal view of the transfer plate illustrated in FIG. 3.

FIGS. 5A and 5B collectively illustrate a circuit diagram of a smart antenna according to an embodiment.

FIG. 6 is a circuit diagram of a power distribution system according to an embodiment.

FIG. 7 is a flow chart of a method for searching, beamforming and tracking according to an embodiment.

FIG. 8 is a top view of a smart antenna according to an embodiment.

FIG. 9 is a flow chart of a method for selecting a beamforming algorithm and reconfiguring circuitry, according to an embodiment.

FIG. 10 is a flow chart of a method for selecting a beamforming algorithm and reconfiguring circuitry, according to another embodiment.

### DETAILED DESCRIPTION

Methods and apparatus for a compact smart antenna are described herein. In one embodiment, the smart antenna contains an array head, a beamformer and a power supply. The array head can be an 8-element array on a ground skirt. The smart antenna can operate, for example, at a frequency of 5.8 GHz with bandwidth of 200 MHz. It should be understood that the 5.8 GHz frequency is illustrative and that the smart antenna can operate at any selected frequency.

The smart antenna can include a beamformer, which can be a digitally-controlled phased analog array system. An on-board FPGA (with or without an external computer) can be included and can automatically perform tasks such as target searching, beamforming and tracking, as described in more detain herein.

The software for the FPGA establishes and maintains a communication link between the beamformer (e.g., the digitally-controlled phased analog array system) coupled to the smart antenna and a radio located at some distance from the system. The FPGA can, for example, search for available targets, form a beam toward that target, and maintain the link by tracking the movement of the target. This software of the FPGA can be stored in flash memory. The smart antenna can interface with radio equipment to receive and transmit (Rx/Tx) signals, which can allow the smart antenna to switch between receive mode and transmit mode as required.

In some embodiments, an apparatus can include a uniform circular array and electronic circuitry. The uniform circular array has multiple antenna elements. Each antenna element is configured to receive a signal from a target and to transmit an output towards the target. The electronic circuitry has a set of components having an interconnectivity. Said another way, each of the sets of components is interconnected. The electronic circuitry is configured to generate the output that is transmitted towards the target via each antenna element. The interconnectivity of the set of components of the electronic circuitry is reconfigurable via a field programmable gate array (FPGA), as described above. The components of a smart antenna can include the uniform circular array, the electronic circuitry and the FPGA. In some embodiments, the uniform circular array can be an eight element circular array.

In some embodiments, a method can include receiving a first signal from a target via a uniform circular array of a smart antenna. The smart antenna is configured to transmit a second signal towards the target via the uniform circular array after the first signal is received. The smart antenna is also configured to define a lobe having a gain and a width. The beamforming algorithm is selected from a set of beamforming algorithms based on criteria associated with at least one of the first signal, the second signal, or the lobe. The criteria includes, for example, at least one of a strength of the first signal, a strength of the second signal, interference signals associated with a location of the target, the gain of the lobe, the width of the lobe, a direction of the first signal or a direction of the second signal. The electronic circuitry of the smart antenna is reconfigured based on the selected beamforming algorithm. The reconfigured electronic circuitry is configured to generate the second signal to be transmitted towards the target via the uniform circular array.

In some embodiments, a method can include selecting a first beamforming algorithm from a set of beamforming algorithms based on a received signal from a target. The set of beamforming algorithms includes at least the first beamforming algorithm and a second beamforming algorithm. The first beamforming algorithm has a performance better than a performance of at least the second beamforming algorithm based on the received signal. The first beamforming algorithm is configured to determine an output to transmit to the target via a uniform circular array of a smart antenna. The smart antenna has electronic circuitry configured to generate an output. The electronic circuitry of the smart antenna is in a first configuration before the selecting and is reconfigured such that the electronic circuitry is in a second configuration after the selecting. The second configuration is associated with the first beamforming algorithm. The smart antenna is configured to generate the output when the electronic circuitry is in the second configuration.

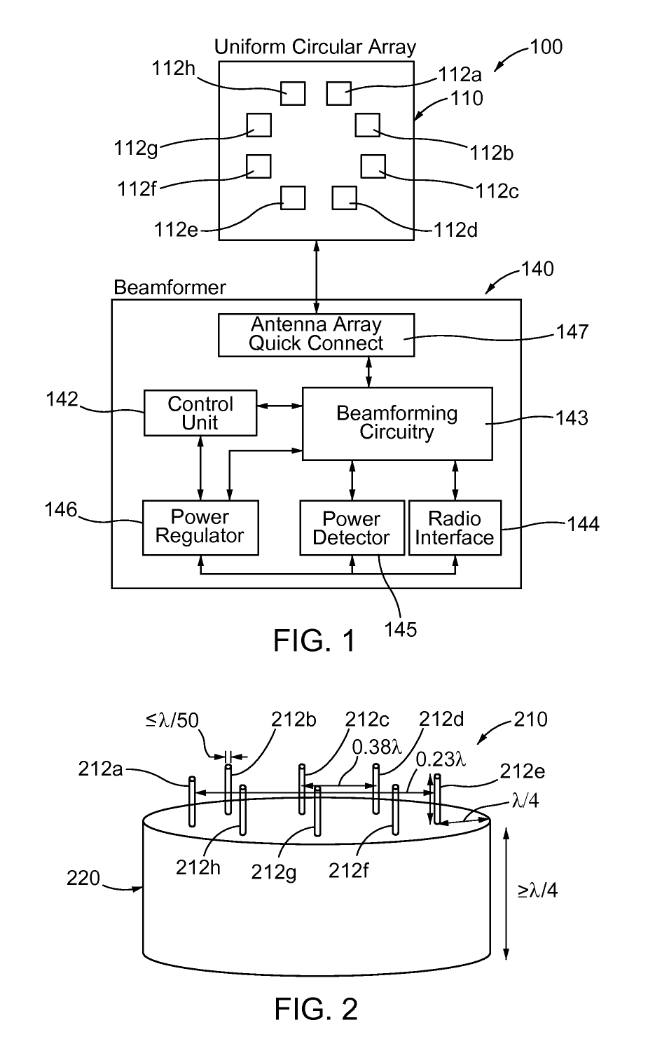

FIG. 1 is a schematic illustration of a smart antenna 100 according to an embodiment. The smart antenna 100 includes a uniform circular array 110 and a beamformer 140. The uniform circular array 110 includes eight antenna elements 112a, 112b, 112c, 112d, 112e, 112f, 112g, and 112h (collectively referred to herein as “antenna elements 112”) arranged in a substantially circular pattern. The antenna elements can be monopole antenna elements, dipole antenna elements or any combination thereof Each of the antenna elements 112 can receive a signal from a target (not shown in FIG. 1) and transmit an output toward the target. Such receiving and transmitting can be performed by one or more of the antenna elements 112 at any point in time. The target can be located any distance away from the smart antenna 100 so long as the target remains within the field of operation of smart antenna 100. The field of operation is dependent on, for example, the operation frequency of the smart antenna 100, as described in detail below. In some embodiments, the target can be a mobile target such as a laptop, cell phone, PDA, a car antenna and/or the like. In other embodiments, the target can be a stationary target.

The antenna elements 112 can have any suitable shape and/or size. The specific length and/or width of antenna element 112 can allow the signal to be coupled to the air (e.g., send and receive signals using electromagnetic waves) with minimal attenuation. In some preferred embodiments, each antenna element 112 is physically robust and resilient to shock and vibration.

The beamformer 140 is configured to process the signal(s) received by one or more of the antenna elements 112 and to generate an output to be transmitted by one or more of the antenna elements 112. The beamformer 140 includes an antenna array quick connect 147, a control unit 142, beamforming circuitry 143, power detector 145, power regulator 146, and a radio interface 144. These components are collectively referred to herein as “beamformer components”. In some embodiments, the beamformer 140 can be implemented on a printed circuit board (PCB), which electrically connects one or more of the above beamformer components.

The beamformer 140 is electrically coupled to the uniform circular array 110 via the antenna array quick connect 147. More particularly, the antenna array quick connect 147 is electrically coupled to the uniform circular array 110 at one end and electrically coupled to the beamformer 140 at the other end. In some embodiments, the antenna array quick connect 147 is composed of transmission lines (e.g., eight 50 ohm transmission lines) that are electrically coupled to an individual antenna element 112 at one end and electrically coupled to the beamformer 140 at the other end. In this manner, the uniform circular array 110 can send the signal(s) received by one or more of the antenna elements 112 to the beamformer 140 via the antenna array quick connect 147. Similarly, the beamformer 140 can send the output(s) to be transmitted by one or more of the antenna elements 112 to the uniform circular array 110 via the antenna array quick connect 147. Said another way, a signal can propagate along the eight 50 ohm transmission lines, which provide minimal attenuation and proper isolation to control the signal coupling.

The control unit 142 is configured to send data (e.g., instructions) to and receive data from each of the beamformer components. Said another way, the control unit 142 controls and monitors the processes of the beamformer 140. The control unit 142 can include, for example, a processor, such as a field programmable gate array (FPGA), to facilitate sending and receiving data.

The beamforming circuitry 143 is configured to generate output such that a signal is transmitted via one or more of the antenna elements 112. Additionally, the beamforming circuitry 143 is configured to process the signal from the target received by one or more of the antenna elements 112. In some embodiments, the beamforming circuitry 143 is directly coupled to the antenna array quick connect 147 such that the beamforming circuitry 143 receives a signal from the uniform circular array 110 via the antenna array quick connect 147.

The beamforming circuitry 143 can include interconnected hardware components such as switches, bandpass filters, phase shifters, and/or any like electronic components. In some embodiments, the configuration (i.e., the interconnectivity) of the hardware components of the beamforming circuitry 143 can be rearranged based on instructions or signals from the control unit 142. In this manner, the beamforming circuitry 143 can perform different functions depending on the configuration of the hardware components.

The power detector 145 is electrically coupled to the beamforming circuitry 143 and configured to receive the signal from the beamforming circuitry 143. The power detector 145 can be configured to generate data associated with the power of the signal, such as, for example, the power level of the signal. Once the power detector 145 generates the data, the power detector 145 is configured to transmit the data to the control unit 142. In some embodiments, the power detector 145 can be configured to generate data associated with other aspects of the signal, such as, for example, the frequency of the signal, the amplitude of the signal, the phase of the signal and the like.

The power regulator 146 is configured to apportion power to each of the beamformer components. In some embodiments, the beamformer 140 can use external power regulation, and power regulator 146 is not present within beamform 140.

The radio interface 144 is configured to receive signals from and/or transmit signals toward the target. In embodiments where the beamformer 140 is a PCB, the radio interface 144 can be located externally from the beamformer 140. In some embodiments, the radio interface 144 can operate in a time division duplex (TDD) mode. In other embodiments, the radio interface 144 can operate in a frequency division duplex (FDD) mode when different arrays are used for transmission and receiving. In yet other embodiments, the radio interface 144 can operate in a dual mode (i.e., in both TDD and FDD mode).

FIG. 2 is a schematic illustration of a uniform circular array 210 with a ground skirt 220 according to an embodiment. The uniform circular array 210 includes eight antenna elements 212a, 212b, 212c, 212d, 212e, 212f, 212g, and 212h (collectively referred to herein as “antenna elements 212”). The antenna elements 212 are coupled to the ground skirt 220 and arranged thereon in a substantially circular pattern. The antenna elements 212 have the same function and operation as the antenna elements 112 described above with reference to FIG. 1. The antenna elements 212 can be constructed from any suitable material such as, for example, brass and/or copper.

The ground skirt 220 is configured to provide a virtual infinite ground plane for the uniform circular array 210 as well as mechanical rigidity. The infinite virtual ground plane can aid in forming a level vertical beam output. The ground skirt 220 can be constructed of any suitable material such as, for example, aluminum.

The sizes of the antenna elements 212 and the ground skirt 220 can be determined, for example, in the following manner. As shown in FIG. 2, each of the antenna elements 212 have a diameter of less than or equal to λ/50, a height of 0.23 λ and an inter-element spacing of 0.38 λ, where λ is a wavelength of the signals each antenna element 212 is configured to receive and/or transmit. In this manner, the size of each antenna element 212 is based, in part, on the operation frequency of the smart antenna. Additionally, the ground skirt 220 has a height of greater than or equal to λ/4.

In some embodiments, the electric size of the uniform circular array 210 can be calculated as kr, where k is the wave number and r is the radius of the uniform circular array 210. When the smart antenna operates at a frequency of 5.8 GHz, for example, the uniform circular array 210 is calculated as having an electric size of 3.0.

The antenna elements 212, the uniform circular array 210 and the ground skirt 220 can have any suitable size, shape and/or dimension based on the above described relationships. For example, when the smart antenna operates at a frequency of 5.8 GHz, each antenna element 212 can have a height of 0.5 inches and a diameter of 0.03 inches. The antenna elements 212 can be connected to the ground skirt 220 in a circular formation having a 1.98 inch diameter and equally spaced every 45 degrees.

Additionally, the ground skirt 220 can be an aluminum ground skirt having 0.5″ in length by 3″ in outer diameter. In some embodiments, the ground skirt 220 can include eight 2-56 by ⅜″ tapped holes, which line the rim of the ground skirt 220 at a radius of 1.288″ separated by 45 degrees. Such tapped holes can provide a connection to a transfer plate, as described below.

In some embodiments, the gain of the uniform circular array 210 can be approximately 12-15 dBi depending on the beamforming algorithm used. In some such embodiments, the operating frequency range (e.g., 200 MHz bandwidth centered at 5.8 GHz) will be in a relatively flat gain range.

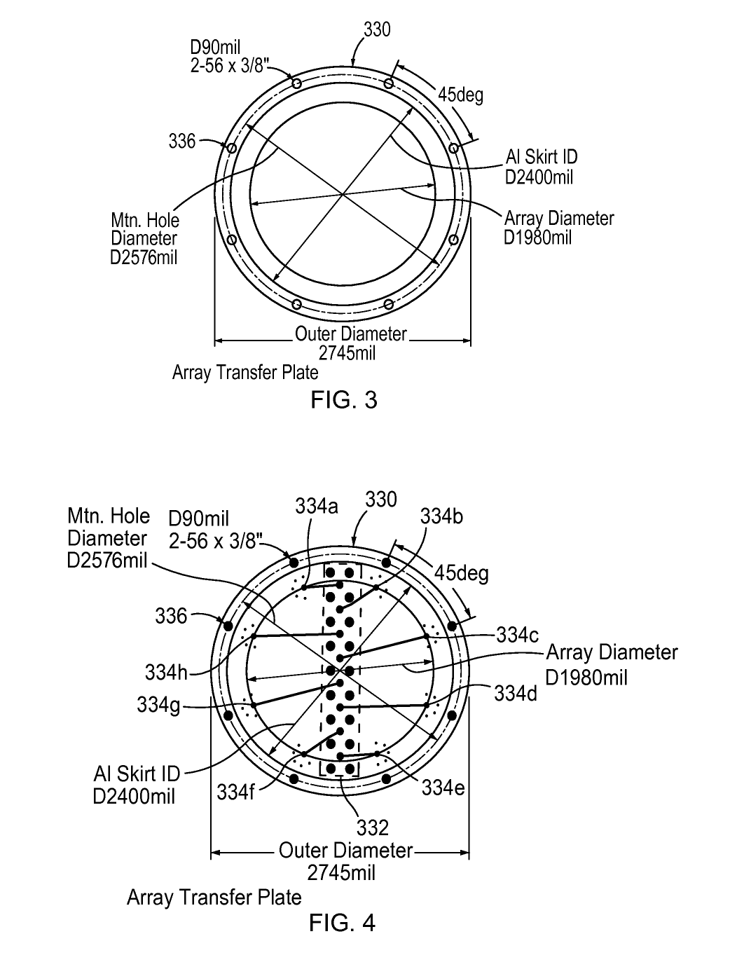

In some embodiments, the ground skirt 220 can be coupled to a transfer plate configured to electrically couple the uniform circular array 210 to a beamformer. For example, FIG. 3 is a top view of a transfer plate 330 according to an embodiment. Additionally, FIG. 4 is an internal view of the transfer plate 330 illustrated in FIG. 3. The transfer plate 330 includes an interconnect 332 and antenna element connections 334a, 334b, 334c, 334d, 334e, 334f, 334g, and 334h (collectively referred to herein as “antenna element connections 334”). Additionally, the transfer plate 330 includes ground skirt connections 336a, 336b, 336c, 336d, 336e, 336f, 336g, and 336h (collectively referred to herein as “ground skirt connections 336”). The ground skirt connections 336 are configured to couple the transfer plate 330 to a ground skirt (e.g., ground skirt 220 illustrated in FIG. 2). As shown in FIGS. 3 and 4, the ground skirt connections 336 are lined around the rim of the transfer plate 330 in a circular pattern and separated by 45 degrees. In some embodiments, the ground skirt connections 336 can be tapped holes. For example, the ground skirt connections 336 can be eight 0.090″ holes around the edge at a radius 1.288″ every 45 degrees to accommodate 2-56 size screws, which allow the transfer plate 330 to be connected properly (or secured) to the ground skirt.

When the transfer plate 330 is secured to the ground skirt, each antenna element connection 334 is electrically coupled to an antenna element (e.g., antenna elements 212 illustrated in FIG. 2).

The interconnect 332 is electrically coupled to each antenna element connection 334. In this embodiment, the interconnect 332 is a solid, interchangeable 50 ohm snapping interconnect configured to matingly receive an antenna array quick connect of a beamformer, as described above. In some embodiments, the antenna array quick connect can be, for example, a solid ganged eight position MCX connector, that snaps into the interconnect 332, thereby electrically coupling the uniform circular array to the beamformer. In this manner, the antenna array quick connect and the transfer plate 330, collectively, allow a smooth transfer of a radio signal between the beamformer and the uniform circular array via the interconnect 332.

In some embodiments, the transfer plate 330 includes a PCB that electrically connects each antenna element connection 334 to the interconnect 332. For example, the PCB can include eight 50 ohm traces laid out in stripline transmission configuration on the inner layer to carry a signal from the interconnect 332 to one or more of the antenna element connections 334 and then to their respective antenna elements.

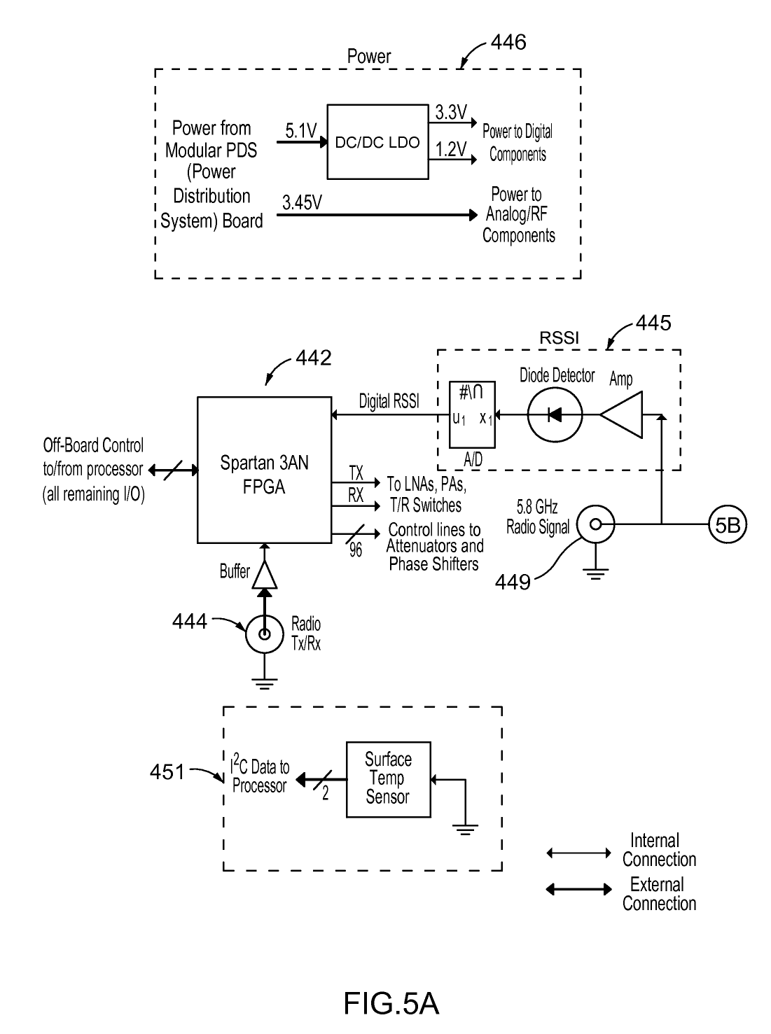

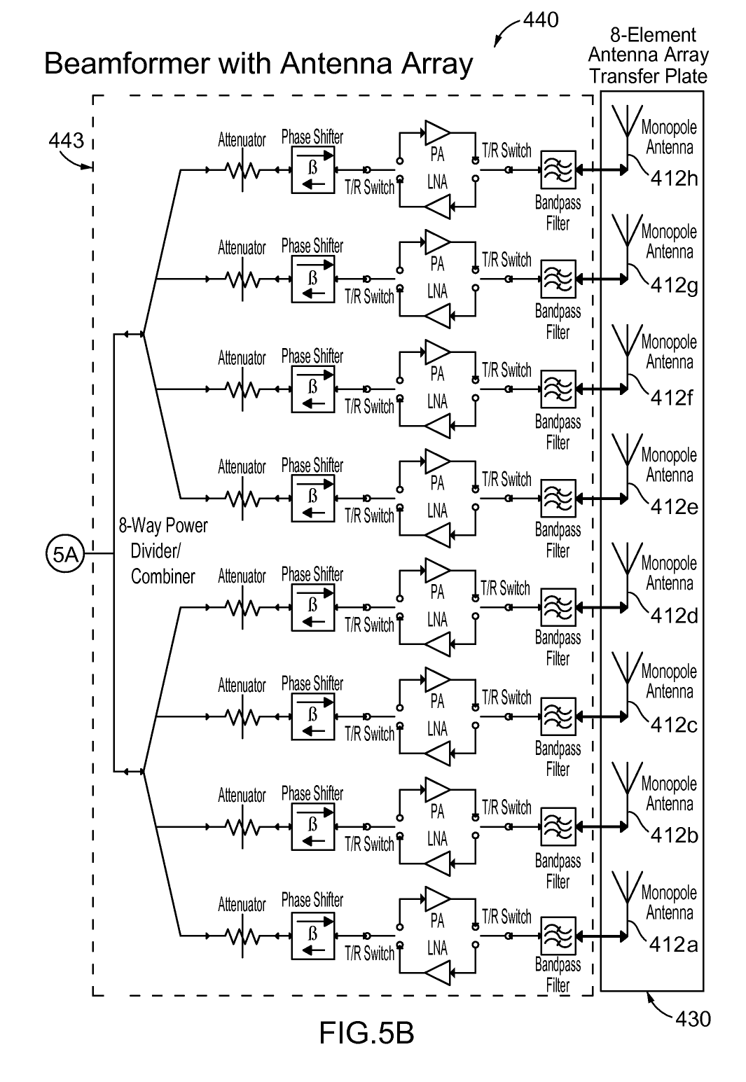

FIGS. 5A and 5B collectively illustrate a circuit diagram of a beamformer 440 according to an embodiment. The beamformer 440 is a digitally-controlled, analog beamforming system. The beamformer 440 includes a control unit 442, analog beamforming circuitry 443, a radio interface 444, power detector 445, power regulator 446 and 448, and a surface temperature sensor 451. These components are collectively referred to herein as “beamformer components”. In some embodiments, the beamformer 440 includes a PCB configured to electrically connect one or more of the beamformer components. In some embodiments, the beamformer 440 includes an antenna array quick connect configured to operate in the same manner described above. In some embodiments, the beamformer 440 does not include the surface temperature sensor 451.

The control unit 442 is configured to provide precise, digital, beamforming control via a field programmable gate array (FPGA). In this embodiment, the FPGA is configured to constantly deliver 96 control lines to eight separate phase shifters (not identified) and eight attenuators (not identified) of the analog beamforming circuitry 443 in, for example, no more than 100 nanoseconds of combined propagation and delay time.

The analog beamforming circuitry 443 includes a power divider/combiner, multiple attenuators, multiple phase shifters, two T/R switches, mutliple amplifier stages for both transmitting an output and receiving a signal, and multiple bandpass filters. In this embodiment, the power divider/combiner is an 8-way power divider/combiner, the attenuator is a 31.5 dB/0.5 dB step 6-bit digital attenuator and the phase shifter is a 360° /5.6° step 6-bit digital phase shifter. After the power divider/combiner, the circuitry is composed of eight sets of the above components, each of which provides an analog path for each of the eight channels, which are each associated with one of antenna elements 412a, 412b, 412c, 412d, 412e, 412f, 412g, or 412h. The eight channels are transmit and receive radio frequency channels, each configured to provide delay-line weighting so that RF beamforming can be accomplished according to weight values determined by the controlling logic beamforming algorithms, as described herein. The receive path (i.e., the path of a received signal) includes two low noise amplifiers giving the beamformer 440 8 dB of receive gain with a noise figure of 6 dB. The transmit path (i.e., the path of an output) provides 7 dB of gain with an achievable output power of 21 dBm with 4% Error Vector Magnitude (EVM) at 54 Mbps.

The radio interface 444 is configured to receive and transmit signals. In some embodiments, the radio interface 444 includes circuitry configured to condition a commercial off the shelf (COTS) radio's T/R signal and to provide current driving capabilities to synchronize all the components of the beamforming circuitry 443 with the T/R signal. In some such embodiments, a combination of low voltage control logic gates and inverters (not shown) can be used to condition the T/R signal and use the T/R signal to drive the switches and amplifiers with a delay no greater than 100 ns. In embodiments where the beamformer 440 is operating as a switched beam system, the radio interface 444 is able to form multiple predefined beams in both Tx and Rx mode (i.e., transmission and receiving mode) using co-phasal excitation, or several window functions, such as, for example, Chebyshev. The radio frequency processing gain in receiving mode is approximately 8 dB and in transmission mode is approximately 7 dB.

The power detector 445 (labeled in FIG. 5A as “RSSI” for received signal strength indication) is configured to receive a signal from the beamforming circuitry 443 and determine the power of the signal. As shown in FIG. 5A, the power detector 445 includes an amplifier (labeled in FIG. 5A as “Amp”), an analog-to-digital converter (labeled in FIG. 5A as “A/D”), and a diode log power detector (labeled in FIG. 5A as “Diode Detector”). A radio component 449 is electrically coupled to the power detector 445. In this manner, the power detector 445 can demodulate the signal received from the beamforming circuitry 445 using the radio component 449.

The radio component 449 and the power detector 445 are collectively configured to be RF power sensing circuitry. Such circuitry is configured to detect the remote wireless devices' carrier signals, and feed the detected signal's information into the search algorithm so it can be used to beamform and track remote signal equipment. In some embodiments, the power detector 445 includes the radio component 449.

In some embodiments, the power detector 445 can have a dynamic range of at least 50 dB and a pulse response time no greater than 15 ns. In some such embodiments, the output of the power detector 445 can be sent to a 10-bit, 100 kilo samples/sec (KSPS) analog-to-digital converter, which then sends the digital signal to the FPGA for evaluation in the search-lock-track algorithms.

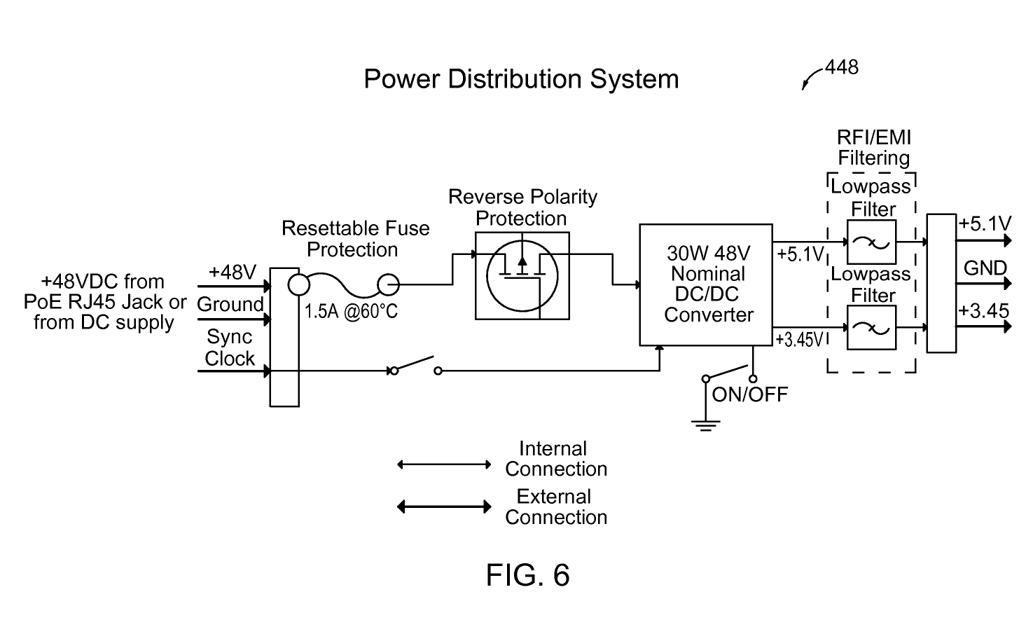

The power regulator 446 is a local power regulator that can be, for example, located on the beamformer PCB. The power regulator 446 is configured to power the digital beamformer components. The beamformer 440 also includes external power regulation 448 via a power distribution system (PDS), as shown in FIG. 6. The PDS 448 is configured to power the analog beamformer components within beamforming circuitry 443. Power supply local regulation via power regulator 446 can be minimumized because a majority of regulation is done by the PDS 448. Power regulator 446 on the beamformer 440 can include low drop-out (LDO) regulators and energy storage components. For example, a dual-output, power sequencing LDO regulation can supply regulation for the FPGA (i.e., control unit 442) and the radio interface circuitry 444. Additionally, a very low-noise LDO can supply power for the RF power detection circuitry to provide a clean reference. In some embodiments, a bank of low ESR, high energy, tantalum caps can provide energy storage at the power input connector to mitigate the high current transients caused by the power amplifiers.

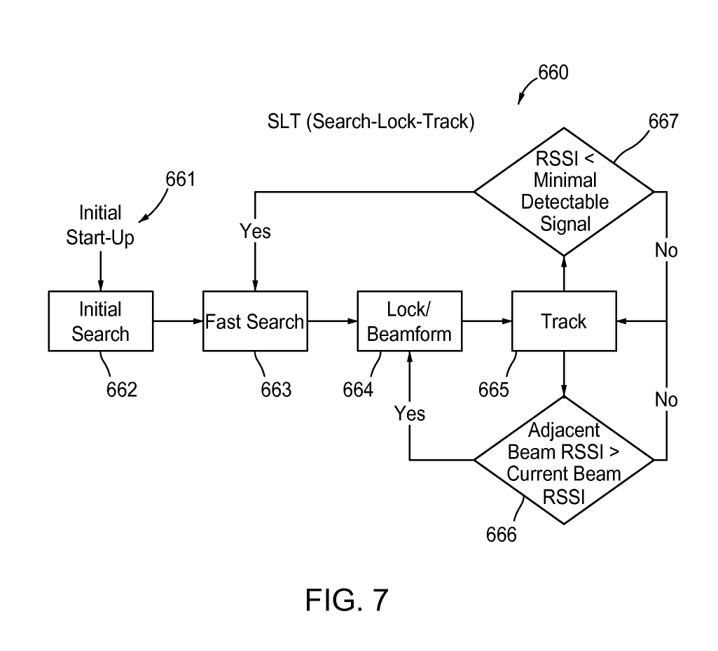

FIG. 7 is a flow chart 660 of a method for searching, beamforming and tracking according to an embodiment. In some embodiments, a software program, which can be stored, for example, within an FPGA in a control unit of a beamformer, can be configured to perform the searching, beamforming and tracking for a smart antenna. After the initial start-up of the smart antenna at 661, the software performs an initial search at 662. During the initial search, a received signal strength indication (RSSI) signal from a connected radio is measured and saved at each predefined direction. The signal with maximal power at the direction of arrival of a desired incoming signal source is selected.

The signal with the maximal power is selected as follows. After identifying the received signals as signals of targets, the received signals are averaged over several sets of consecutive phase delays, and the beam that has the largest outcome is selected. Before the operation, the set M of the spatial signatures of the fixed beams is predetermined and saved in the system. Each beam m has a specified spatial signature αₘ (φ), m=1, 2, . . . , M. For an m-element circular array, M can be chosen as qm, where q=1,2, . . . Q, with 360°/Q≧ 1/10 of the beamwidth. The switched beam array output vector is

Sₘ (t)=(α₁, α₂ . . . , α_{M})^{H} x(t),

where x(t) is the total signal vector received by the array, the superscript H is conjugate transpose. Assuming only one target, when an α*ₘ (φ) is equal or very close to the signal spatial signature α*ₖ (φ), the mth element in output vector will be equal or very close to the signal strength received: sₘ(t)≅(0,0 . . . , \sqrt{Pₘ}, . . . 0)^{T}. Thus, the target is in the region of mth beam. The location of the user can be routinely updated via a “fast search” at 663 as described in this paragraph.

Beam switching algorithms can determine when a particular beam can be selected to maintain a desired or highest quality signal as selected from the various beam switching algorithms. The smart antenna continuously updates beam selection to ensure the quality of the communication. The smart antenna switches over the outputs of each beam and selects the beam with maximal signal strength as well as suppressing interference arriving from the direction away from the active beam's center.

When the desired signal is known, a reference signal can be used to convolve with the incoming signal and calculate the cross correlation coefficients. Complex correlation peaks corresponding to the unique signal are detected by a predefined voltage threshold or a template matched filter for signal validation. This signal validation process can also be done after the phased array process.

Once the arrival angle is known, the corresponding coefficients for beamforming can be determined at 664. This can be done by sending control bits to all 96 control lines from the FPGA shown in FIG. 5A and setting the digital phase shifters and attenuators with the correct phase delays and magnitudes. This control electronically forms and steers a high gain directional beam for transmission and reception. When connected with a radio, the smart antenna receives an exterior transmit/receive (T/R) signal to synchronize with the radio.

The beamforming algorithms can include, for example, co-phasal excitation and window beamforming algorithms. The co-phasal excitation beamforming algorithm can be based on the knowledge of the direction of the target. Once the desired direction is known, the smart antenna (here mainly as a receiving antenna system) can choose one sector in active mode and a properly selected phase delay is applied. Thus, the signal from that specific direction will have the maximal gain. The data of direction of the target can be updated as required. In a TDD system where the uplink and downlink share the same carrier, a weight vector of the smart antenna can be designed and kept based on the spatial signature received at ith time slot such that wᵢ=α*ᵢ for the downlink. At the jth slot, the signal received by the mobile user will be (α*ᵢαⱼ)s(t), where αᵢ and αⱼ are normalized vectors. If the update rate is fast enough or the relative change ≈0, the smart antenna will receive maximal signal power. However, if the update rate is slow so that |α*ᵢαⱼ|≈0 or the relative change≈100%, the smart antenna will not receive any signal power. In practice, a threshold should be set to determine which beam should be active. For communicating with more than one user and to save energy a beam can stay at a direction, i.e. serve one canister as long as possible.

In the window beamforming algorithm, the channel signals are shaped by a window function (e.g., like Chebyshev, Hamming, Hanning, cosine, triangular, or the like) to reduce the side lobes of beam patterns. Using non-adaptive windowed beamformers is the simplest way to beamform to maximize the signal-to-interference ratio of a switched beam array. By controlling the side lobes in a non-adaptive windowed array, most interference can be reduced to insignificant power.

In some embodiments, the user is allowed to define the type of beamforming algorithm that the FPGA uses. For example, the FPGA can use either the co-phasal excitation beamforming algorithm or the window beamforming algorithm. In other embodiments, the FPGA can determine which beamforming algorithm would be the most appropriate to use at a given time.

When only one target is present, the target will not change its location dramatically (i.e., the direction of arrival from the desired target will not change much during the communication). For example, assume that an initial time, a beam m is chosen. To update, the signal strength from beam m is compared to its neighbor beams: beam m−1 and beam m+1, and the strongest beam is chosen as the updated beam. The tracking cycle is properly chosen so that the target will not travel out of the small range (between beam m−1 to beam m+1). In some embodiments, when there are multiple mobile users (i.e., canisters), the communication system can have a table to record the location of each target. In some such embodiments, the table can be updated periodically.

Referring to FIG. 7, the tracking at 665 operates on the assumption that in the time it takes the method (e.g., the software in FPGA) to complete one cycle, a target will not move more than 20 degrees off of its previous position. The incoming signal strength from the current direction can be compared to the incoming signal strength from the adjacent directions. The direction with strongest signal strength will be chosen as the new target direction.

If the incoming signal strength for the current direction is determined to be greater than the incoming signal strength for the adjacent directions at 667, then the current direction and the beamforming is maintained and fast searching is repeated at 663. If the incoming signal strength for an adjacent direction is greater than the incoming signal strength for the current direction at 666, then the adjacent direction is selected and a new beam formed at 664

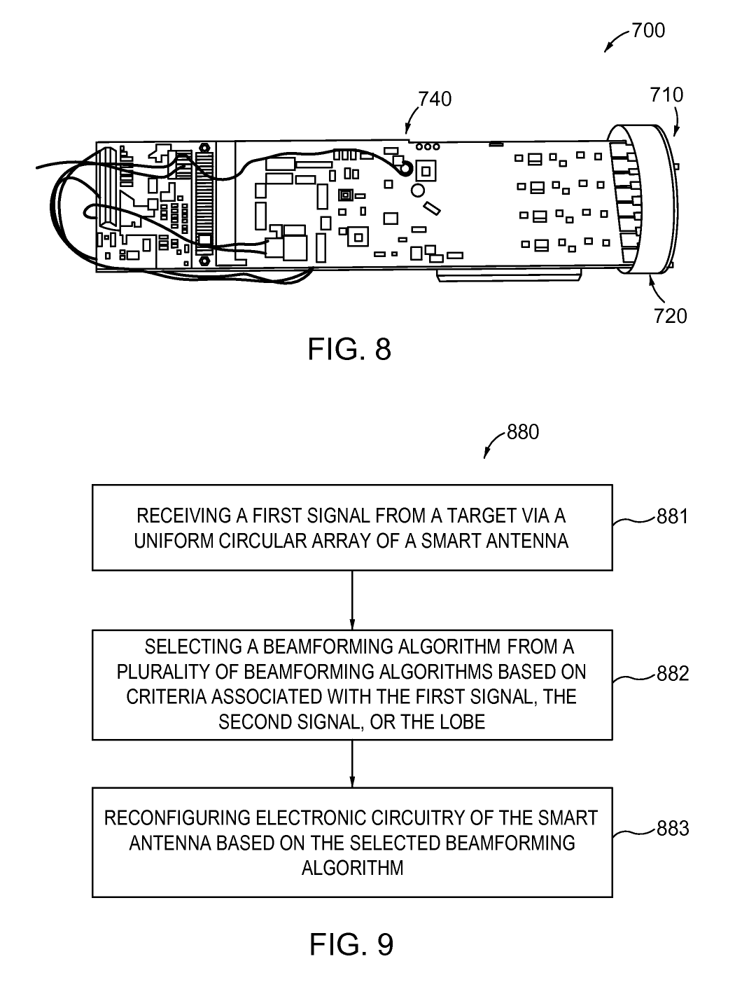

FIG. 8 is a top view of a smart antenna 700 according to an embodiment. The smart antenna 700 includes a beamformer board 740, a uniform circular array 710 and a ground skirt 720. As described above, the uniform circular array 710 is coupled to the ground skirt 720. The uniform circular array 710 and ground skirt 720 can have the same structure and operation, for example, as the uniform circular array 210 and ground skirt 220 illustrated and described with reference to FIG. 2.

The beamformer board 740 is a printed circuit board (PCB) that can include firmware logic and algorithms for smart antenna functions, power detection circuitry and Tx/Rx radio device interface circuitry similar to those discussed above. The beamformer board 740 can have the same or similar circuit/component connectivity and operation as the beamformer 440 illustrated and described with reference to FIG. 5B. In some embodiments, the beamformer board 740 can be electrically coupled to the uniform circular array 710 and ground skirt 720 via a transfer plate in the same manner described above.

The beamformer board 740, the uniform circular array 710 and the ground skirt 720 can provide mechanical function as well as an electrical function to transmit and receive a signal into/from the air with minimal attenuation and distortion, particularly at the proper frequency.

In some embodiments, the smart antenna 700 can be designed, for example, to reside in a cylindrical packaging measuring 3″ in diameter and 18″ long. Such packaging can include all sub-components of the smart antenna 700 (i.e., the high gain antenna system).

FIG. 9 is a flow chart of a method 880 for choosing an algorithm according to an embodiment. The method includes receiving a first signal from a target via a uniform circular array of a smart antenna, 881. The smart antenna can be configured to transmit a second signal towards the target via the uniform circular array after the first signal is received. The second signal can be any suitable output, such as, for example, a beam (also including nulls). The smart antenna can also be configured to define a lobe having a gain and a width. The lobe can be any suitable lobe, such as, for example, a main lobe or a side lobe. The gain of the lobe can be any suitable gain, and the width of the lobe can be any suitable width. In some embodiments, the uniform circular array is an eight element uniform circular array. In some embodiments, the target can be a mobile device, such as a laptop, cell phone, PDA and/or the like.

The method includes selecting a beamforming algorithm from a set of beamforming algorithms based on criteria associated with at least one of the first signal, the second signal, or the lobe, 882. The criteria can include, for example, at least one of a strength of the first signal, a strength of the second signal, the gain of the lobe, the width of the lobe, a direction of the first signal or a direction of the second signal. In some embodiments, the criteria can include the amount of interference signals associated with a location of the target and/or a strength of one or more of such interference signals. In some embodiments, the interference signals can indicate whether the target is in a urban location having a high amount of interference signals, or in a rural location having a low amount of interference signals. In some embodiments, the selected beamforming algorithm is the beamforming algorithm from the set of beamforming algorithms that can provide an increased signal performance to the target.

At 883, electronic circuitry of the smart antenna can be reconfigured based on the selected beamforming algorithm. The reconfigured electronic circuitry can be configured to generate the second signal to be transmitted towards the target via the uniform circular array. In some embodiments, the reconfiguring is performed by a field programmable gate array (FPGA). In this manner, the FPGA can reconfigure the interconnectivity of the hardware components (i.e., the electronic circuitry) using software.

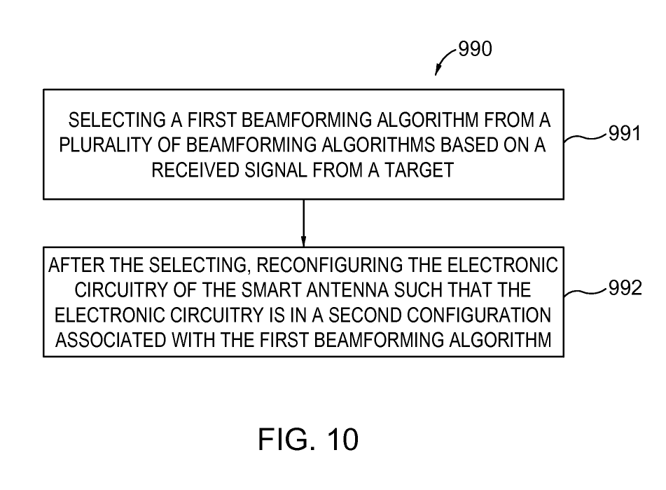

FIG. 10 is a flow chart of a method 990 for changing an algorithm according to an embodiment. A first beamforming algorithm from a set of beamforming algorithms can be selected based on a received signal from a target, 991. The set of beamforming algorithms includes at least the first beamforming algorithm and a second beamforming algorithm. The first beamforming algorithm can have a performance better than a performance of at least the second beamforming algorithm for the received signal. Such a performance can be representative of, for example, a signal strength associated with the beamforming algorithm.

The first beamforming algorithm can be configured to determine an output to transmit to the target via a uniform circular array of a smart antenna. The electronic circuitry of the smart antenna can be in a first configuration before the first beamforming algorithm is selected. In some embodiments, the output can be a beam. In some embodiments, the uniform circular array can be an eight element uniform circular array.

At 992, the electronic circuitry of the smart antenna can be configured such that the elecronic circuitry is in a second configuration associated with the first beamforming algorithm. The smart antenna can be configured to generate the output when the electronic circuitry is in the second configuration. In some embodiments, the reconfiguring is performed by a field programmable gate array (FPGA). In this manner, the FPGA can reconfigure the interconnectivity of the hardware components (i.e., the electronic circuitry) using software.

While various embodiments of the invention have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Although the uniform circular array is illustrated and described above as being an eight element uniform circular array, in should be understood that the uniform circular array can have any number of antenna elements.

In some embodiments, any one of the beamformer components (e.g., the controlling unit) can include a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of embodiments where appropriate.

What is claimed is:

1. An apparatus, comprising:
a uniform circular array having a plurality of antenna elements, each antenna element configured to receive a signal from a target and to transmit an output towards the target; and
electronic circuitry having a plurality of components having an interconnectivity, the electronic circuitry configured to generate the output transmitted towards the target via each antenna element, the interconnectivity of the plurality of components of the electronic circuitry being reconfigurable via a field programmable gate array (FPGA).

2. The apparatus of claim 1, wherein each antenna element from the plurality of antenna elements is a monopole antenna element.

3. The apparatus of claim 1, wherein the uniform circular array includes a transfer plate configured to electrically couple the plurality of antenna elements to the electronic circuitry.

4. The apparatus of claim 1, wherein the plurality of components of the electronic circuitry include at least one of a switch, a bandpass filter, a phase shifter, a power combiner, a power divider, or an attenuator.

5. The apparatus of claim 1, wherein the electronic circuitry is configured to operate in a switch-beam mode when the interconnectivity of the plurality of components of the electronic circuit is in a first configuration, the electronic circuitry is configured to operate in an adaptive array mode when the interconnectivity of the plurality of components of the electronic circuit is in a second configuration different from the first configuration.

6. The apparatus of claim 1, wherein the FPGA is configured to implement a plurality of beamforming algorithms, the interconnectivity of the plurality of components of the electronic circuitry being reconfigurable via the FPGA based on a beamforming algorithm selected from the plurality of beamforming algorithms.

7. The apparatus of claim 1, wherein the uniform circular array is configured to switch between operating in a receive mode and a transmit mode based on a radio signal.

8. A method, comprising:
receiving a first signal from a target via a uniform circular array of a smart antenna, the smart antenna configured to transmit a second signal towards the target via the uniform circular array after the first signal is received, the smart antenna configured to define a lobe having a gain and a width;
selecting a beamforming algorithm from a plurality of beamforming algorithms based on criteria associated with at least one of the first signal, the second signal or the lobe, the criteria includes at least one of a strength of the first signal, a strength of the second signal, a plurality of interference signals associated with a location of the target, the gain of the lobe, the width of the lobe, a direction of the first signal, or a direction of the second signal; and
reconfiguring electronic circuitry of the smart antenna based on the selected beamforming algorithm, the reconfigured electronic circuitry configured to generate the second signal to be transmitted towards the target via the uniform circular array.

9. The method of claim 8, wherein the selected beamforming algorithm is a first selected beamforming algorithm, the smart antenna is configured to operate as a switch beam system when the electronic circuitry of the smart antenna is reconfigured based on the first selected beamforming algorithm, the method further comprising:
selecting a second beamforming algorithm from the plurality of beamforming algorithms; and
reconfiguring the electronic circuitry of the smart antenna based on the second selected beamforming algorithm, the smart antenna being configured to operate as an adaptive array system when the electronic circuitry of the smart antenna is reconfigured based on the second selected beamforming algorithm.

10. The method of claim 8, further comprising:
recording a location of the target based on the first signal, the location of the target being updated periodically to track the target.

11. The method of claim 8, wherein the electronic circuitry includes a plurality of components having an interconnectivity, the reconfiguring including reconfiguring the interconnectivity of the plurality of components of the electronic circuitry of the smart antenna based on the selected beamforming algorithm.

12. The method of claim 8, wherein the selected beamforming algorithm is configured to provide a signal performance better than a signal performance of each remaining beamforming algorithm from the plurality of beamforming algorithms when the selected beamforming algorithm is selected.

13. The method of claim 8, wherein the receiving includes receiving the first signal from the target via monopole antenna elements of the uniform circular array of the smart antenna.

14. A method, comprising:
selecting a first beamforming algorithm from a plurality of beamforming algorithms based on a received signal from a target, the plurality of beamforming algorithms including at least the first beamforming algorithm and a second beamforming algorithm, the first beamforming algorithm configured to determine an output to transmit to the target via a uniform circular array of a smart antenna, the first beamforming algorithm having a performance better than a performance of at least the second beamforming algorithm, the smart antenna having electronic circuitry configured to generate an output, the electronic circuitry of the smart antenna being in a first configuration before the selecting; and
after the selecting, reconfiguring the electronic circuitry of the smart antenna such that the electronic circuitry is in a second configuration associated with the first beamforming algorithm, the smart antenna configured to generate the output when the electronic circuitry is in the second configuration.

15. The method of claim 14, wherein the selecting occurs at a first time, the method further comprising:
selecting the second beamforming algorithm from the plurality of beamforming algorithms based on a second received signal from the target at a second time after the first time, the second beamforming algorithm configured to determine a second output to transmit to the target via the uniform circular array of the smart antenna, the second beamforming algorithm having a performance better than a performance of at least the first beamforming algorithm at the second time; and
after the selecting the second beamforming algorithm, reconfiguring the electronic circuitry of the smart antenna such that the electronic circuitry is in a third configuration associated with the second beamforming algorithm, the smart antenna configured to generate the second output when the electronic circuitry is in the third configuration.

16. The method of claim 15, wherein the smart antenna is configured to operate as a switched-beam system when the electronic circuitry is in the second configuration associated with the first beamforming algorithm, the smart antenna is configured to operate as an adaptive array system when the electronic circuitry is in the third configuration associated with the second beamforming algorithm.

17. The method of claim 14, wherein the first beamforming algorithm is a window beamforming algorithm and the second beamforming algorithm is a co-phasal excitation beamforming algorithm.

18. The method of claim 14, wherein the smart antenna is configured to operate as a switched-beam system when the electronic circuitry is in the first configuration, the smart antenna is configured to operate as an adaptive array system when the electronic circuitry is in the second configuration associated with the first beamforming algorithm.

19. The method of claim 14, wherein the electronic circuitry includes a plurality of components having an interconnectivity, the interconnectivity of the plurality of components of the electronic circuitry of the smart antenna being in the first configuration before the selecting, the reconfiguring including reconfiguring the interconnectivity of the plurality of components of the electronic circuitry of the smart antenna such that the interconnectivity of the plurality of components of the electronic circuitry is in the second configuration associated with the first beamforming algorithm.

20. The method of claim 14, further comprising:
determining a location of the target based on interference signals associated with the location of the target,
the selecting including selecting the first beamforming algorithm from the plurality of beamforming algorithms based on the received signal from the target and the determined location of the target.
